(19) United States
(12) Patent Application Publication
(10) Pub. No.: US 2018/0255063 A1
(43) Pub. Date: Sep. 6, 2018

(54) SYSTEM AND METHOD FOR PROVIDING A DECISION ENGINE WITH DATA FROM A QUERY SERVER

(71) Applicant: Verum View Ltd., Netanya (IL)

(72) Inventors: Maxim POLYACHENKO, Rishon LeZion (IL); Jonathan PAZI, Tel Aviv (IL)

(73) Assignee: Verum View Ltd., Netanya (IL)

(21) Appl. No.: 15/974,260

(22) Filed: May 8, 2018

Related U.S. Application Data
(63) Continuation of application No. PCT/US2016/060918, filed on Nov. 8, 2016.
(60) Provisional application No. 62/253,147, filed on Nov. 10, 2015.

(51) Int. Cl. H04L 29/06; G06F 17/30; G06N 5/02

(52) U.S. Cl. CPC H04L 63/10; G06Q 40/025; G06N 5/02; G06F 17/3069

(57) ABSTRACT

A system and method for method for providing data to decision engines. The method includes: providing an alternate login frame to a user device accessing a website; receiving, from a host server, an authentication token for accessing data stored in an electronic mail server, when login credentials are successfully provided via the alternate login frame; sending the received authentication token to the electronic mail server; upon being granted access to at least a portion of the data stored in the electronic mail server, determining, based on the at least a portion of the data, a vector of variables, the vector including at least one set of variables; and sending, to a decision engine in real-time, the determined vector.

### CROSS-REFERENCE TO RELATED APPLICATIONS

This application is a continuation of International Application No. PCT/US2016/060918 filed Nov. 8, 2016 which claims the benefit of U.S. Provisional Application No. 62/253,147 filed on Nov. 10, 2015, the contents of which are hereby incorporated by reference.

### TECHNICAL FIELD

The present disclosure relates generally to decision engines, and more particularly to collecting data for utilization by decision engines.

### BACKGROUND

Decision engines are computer applications for providing decisions or recommendations to problems. A decision engine may be fed or otherwise provided variables which collectively describe a problem and, based on the provided variables, may determine an appropriate decision or recommendation.

An increasing number of transactions are being processed online rather than in the “real” world. Due to the high number of transactions requiring processing, service providers face challenges in processing such transactions. As an example, loan companies implementing online approvals of loans must be able to rapidly decide which loans may be approved. As the sheer volume of loan requests does not permit a human to process each and every loan application, decision engines are increasingly being utilized for these and other types of online transactions.

A particular kind of decision engine utilized for online transactions is known as a risk engine. Risk engines may be utilized, for example, to determine the likelihood that a borrower will default on a loan based on variables such as age, income, marital status, and the like. Risk engines may be based on, e.g., statistical models, neural networks, machine learning, or heuristics.

In many decision engines, additional data allows for improved processing and determinations of decisions. Specifically, decision engines typically can arrive at more accurate decisions, can arrive at decisions more quickly, or both, when more data is available than when less data is available. Due to the typical presence of a wide variety of relevant information included in electronic mail, a particular source of potentially useful data is electronic mail accounts.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for method for providing data to decision engines. The method includes: providing an alternate login frame to a user device accessing a website; receiving, from a host server, an authentication token for accessing data stored in an electronic mail server, when login credentials are successfully provided via the alternate login frame; sending the received authentication token to the electronic mail server; upon being granted access to at least a portion of the data stored in the electronic mail server, determining, based on the at least a portion of the data, a vector of variables, the vector including at least one set of variables; and sending, to a decision engine in real-time, the determined vector.

Certain embodiments disclosed herein also include a non-transitory computer readable medium having stored thereon instructions for causing one or more processing units to execute a method, the method comprising: providing an alternate login frame to a user device accessing a website; receiving, from a host server, an authentication token for accessing data stored in an electronic mail server, when login credentials are successfully provided via the alternate login frame; sending the received authentication token to the electronic mail server; upon being granted access to at least a portion of the data stored in the electronic mail server, determining, based on the at least a portion of the data, a vector of variables, the vector including at least one set of variables; and sending, to a decision engine in real-time, the determined vector.

Certain embodiments disclosed herein also include a system for providing data to decision engines. The system comprises: a processing circuitry; and a memory, the memory containing instructions that, when executed by the processing circuitry, configure the system to: provide an alternate login frame to a user device accessing a website; receive, from a host server, an authentication token for accessing data stored in an electronic mail server, when login credentials are successfully provided via the alternate login frame; send the received authentication token to the electronic mail server; upon being granted access to at least a portion of the data stored in the electronic mail server, determine, based on the at least a portion of the data, a vector of variables, the vector including at least one set of variables; and send, to a decision engine in real-time, the determined vector.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram illustrating a query server implemented according to an embodiment.

FIG. 2 is a flowchart illustrating a method for providing a decision engine with data from a query server according to an embodiment.

FIG. 3 is a network diagram illustrating deployment of a query server utilized to describe the various disclosed embodiments.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Some example embodiments disclosed include a method and system for providing data from a query server to a decision engine. In particular, data from an electronic mail account accessible to the query server may be provided. An alternate login frame for allowing a user to enter electronic mail credentials on a website associated with a decision engine is provided. An authentication token for providing access to an electronic mail account of the user is received at a query server. A vector of variables is generated and sent to the decision engine in real-time. The vector of variables may include a first plurality of identify variables, a second plurality off credit variables, and/or a third plurality of affordability variables.

The disclosed embodiments allow for incorporation of data from electronic mail accounts and other data from hosted services into decision engines for decision making purposes. As a result, the disclosed embodiments typically allow for processing that faster, more accurate, and/or more secure. Further, some disclosed embodiments utilize authentication procedures for providing data to decision engines, thereby increasing security of the data provision.

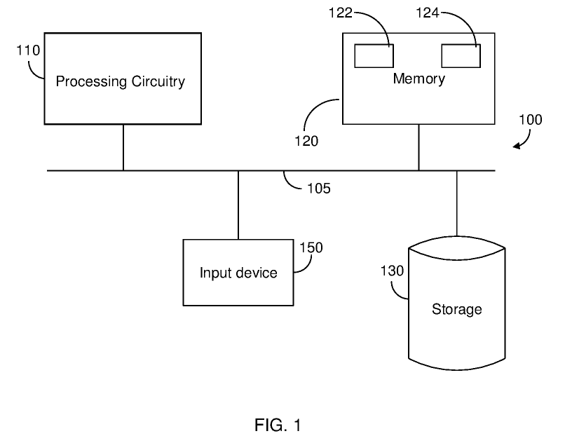

FIG. 1 shows an example schematic diagram of a query server 100 implemented according to an embodiment. In the example diagram shown in FIG. 1, the query server 100 includes a processing circuitry 110, a memory 120, a storage 130, and an input device 150. In some embodiments, the components of the query server 100 may be communicatively connected via a bus 105.

The processing circuitry 110 may be realized as one or more hardware logic components and circuits. For example, and without limitation, illustrative types of hardware logic components that can be used include field programmable gate arrays (FPGAs), application-specific integrated circuits (ASICs), system-on-a-chip systems (SOCs), general-purpose microprocessors, microcontrollers, digital signal processors (DSPs), and the like, or any other hardware logic components that can perform calculations or other manipulations of information.

In an embodiment, the memory 120 includes a first memory portion 122 for storing instructions. The memory 120 may further include a second memory portion 124 storing a vector of variables related to a user email account. The memory 120 may also be used as a working scratch pad for the processing circuitry 110, as a temporary storage, and for other purposes. The memory 120 may be volatile (e.g., RAM, etc.), non-volatile (e.g., ROM, flash memory, etc.), or a combination thereof.

The processing circuitry 110, the memory 120, or both, may also include machine-readable media for storing software. Software shall be construed broadly to any type of instructions, whether referred to as software, firmware, middleware, microcode, hardware description language, or otherwise. The instructions may include code (e.g., in source code format, binary code format, executable code format, or any other suitable format of code). The instructions, when executed by the one or more processors, cause the processing circuitry 110 to perform the various processes described herein. Specifically, the instructions, when executed, cause the processing circuitry 110 to provide data (and, in particular, electronic mail data) from query servers to decision engines.

In another configuration, computer readable instructions to implement one or more embodiments disclosed herein may be stored in the storage 130. The storage 130 may be magnetic storage, optical storage, and the like, and may be realized, for example, as flash memory or other memory technology, CD-ROM, Digital Versatile Disks (DVDs), or any other medium which can be used to store the desired information.

The processing circuitry 110 may be further communicatively connected to an input device 150. The input device 150 may be utilized, for example, for receiving electronic mail data to be provided to a decision engine.

It should be understood that the embodiments described herein are not limited to the specific architecture illustrated in FIG. 1, and other architectures may be equally used without departing from the scope of the disclosed embodiments.

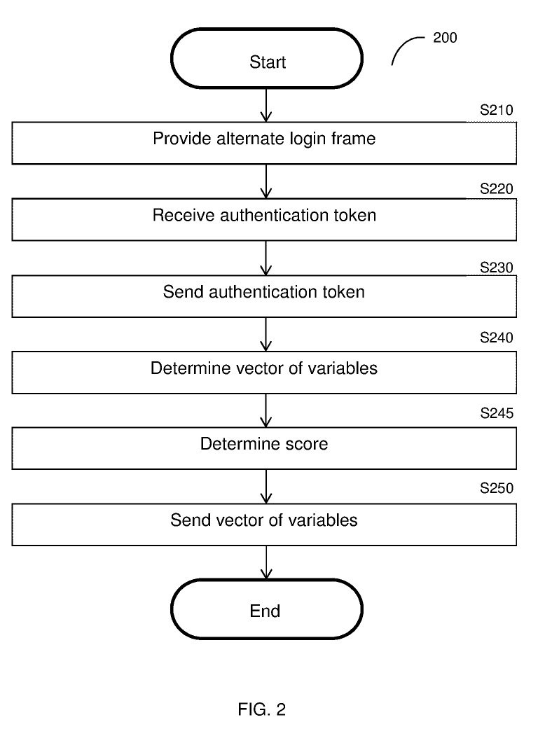

FIG. 2 is an example flowchart 200 illustrating a computerized method for providing data from a query server to a decision engine according to an embodiment. In an embodiment, the method may be performed by the query server 100. The query server 100 may be communicatively connected to a host server hosting a service such as, but not limited to, an electronic mail service having a plurality of electronic mail accounts. In another embodiment, the decision engine may be a risk engine. A risk engine, also known as a risk management system, provides a set of organizational and analytic capabilities to aid in evaluating risks of, for example, a transaction. It should be noted that the disclosure is not limited to risk engines, and that other decision engines may be implemented according to the disclosed embodiments.

At S210, when a user device accesses a website associated with the decision engine (e.g., a website providing electronic mail services hosted by a server communicatively connected to the decision engine), an alternate login frame is provided to the user device. An alternate login frame may be provided upon receive a request (e.g., HTTP request to log to website. The alternate login frame is generated instead of a conventional login frame, when the login is not performed or otherwise authorized by the device engine. The alternate login frame may allow a user of the user device to enter, for example, login credentials of an electronic mail account of the user.

In an embodiment, S210 may further include determining whether the user of the user device is associated with an account (e.g., an electronic mail account) of a service supported by the query server. A service may be supported by the query server if, for example, the query service can access a host server hosting the service. Determining whether the user of the user device is associated with an account may be based on, but not limited to, a user name of the user, a device identifier associated with the user device, a combination thereof, and the like. In a further embodiment, the alternate login frame may be provided to the user device only upon determination that the user of the user device is associated with an account of a service supported by the query server.

In another embodiment, the alternate login frame may be provided to a website associated with the decision engine, and the decision engine website provides the alternate login frame to the user device.

At S220, an authentication token is received. The authentication token may be received from a host server hosting the electronic mail service utilized by the user of the user device. The authentication token may be utilized in providing access to electronic mail data of the user. The authentication token may be provided, e.g., upon the user successfully providing electronic mail credentials of an electronic mail account.

At S230, the authentication token is sent to an email server and, upon receipt of the authentication token at the email server, access to the electronic mail account is granted to, e.g., the query server. In another embodiment, S230 may further include receiving, from the host server, login credentials for obtaining direct access to the electronic mail account. Utilization of authentication tokens for accessing email servers increases security by ensuring that access to email server data is only granted when a user associated with the accessed data has permissions related to the data.

At S240, upon granting access to the electronic mail account, a vector of variables is determined. The vector of variables includes at least one set of variables, where each set of variables further includes at least one variable. In an example implementation, the vector of variables includes a first set of identity variables, a second set of credit variables, and a third set of affordability variables. In an embodiment, S240 may include querying the email server for data related to each set of variables and the vector may be determined based on the results of the query. In a further embodiment, a query may be initiated for each variable to determine its value.

The query may be based on, but not limited to, variables of a particular user (e.g., variables received from the decision engine), information related to the electronic mails themselves (e.g., times, senders, recipients, subject headers, etc.), keywords associated with types of variables (e.g., the term “amount due” for variables indicating debts or unpaid bills), and the like. In an example implementation, the sets of variables may include, but are not limited to, a set of identity variables, a set of credit variables, and a set of affordability variables.

The identity variables indicate information utilized to, e.g., authenticate user identifications, decrease the risk of identity fraud, or both. Example identity variables may include, but are not limited to, a match of a full name of a user, a match of a phone number of the user (e.g., a home phone number or a cell phone number), a match of an address of the user, an amount of time an email account has been active for, an amount of activity of the user on social media websites, and the like. The amount of time the electronic mail account has been active for may be determined by, for example, searching for an oldest email sent from the electronic mail account.

Matches between identity variables may be determined, for example, by receiving values (from, e.g., the decision engine) for each of the variables and querying the electronic mail account for a value corresponding to each received value. As an example, a home address of “123 ABC Street, Morristown, N.J.” may be received from the decision engine, and a match may be determined by querying the electronic mail account for the received home address and receiving a result including the received home address. In a further embodiment, the match may be determined to be within a range of values, for example, a match of 90%, where the 90% may represent, e.g., a certainty that a home address is a home address of the user. As a non-limiting example, based on results of a query for online orders of personal items, it may be determined that 90% of online orders are associated with a first delivery address, and that 10% of online orders are associated with a second delivery address. Accordingly, it may be determined that there is a 90% certainty that the first address is a home address. This may be because, for example, it is typical for online orders to be received at a home address. In yet a further embodiment, a match may be determined only if the matching is above a predetermined threshold.

Example credit variables may include, but are not limited to, variables indicating online shopping transactions (e.g., frequency, amounts, etc.), luxury purchases, regular spending (e.g., weekly, monthly, or annual spending), curriculum vitae (CV, also known as resume) information (e.g., past employers, most recent employer, education, etc.), and the like. Such credit variables may be binary (e.g., yes or no), numerical, textual, or a combination thereof.

Example affordability variables may include, but are not limited to, presence of overdue bills, presence of unpaid bills, presence of outstanding debts, estimated income, and the like. In an embodiment, S440 may include estimating the income of the user by, for example, searching for a job title in signatures of outgoing emails and, upon identifying a job title, determining an income for the identified job title. In a further embodiment, determining the income may include querying a database of job titles and associated incomes. The determined income may be an average income for, e.g., people having the identified job title, for people in the same area, a combination thereof, and the like.

In a further example, the sets of variables may further include a set of business intelligence (BI) variables. An example BI variable may indicate that a loan was taken from a competitor business.

In another embodiment, the vector of variables and, in particular, the sets of variables included in the vector, may be determined further based on the decision engine to which the vector of variables will be sent. Different decision engines may utilize different data to determine decisions or recommendations and, accordingly, sending only data utilized by a particular decision engine or type of decision engine may allow for decreased usage of computing resources related to obtaining variables, storing variables, sending variables, or a combination thereof.

At optional S245, a score may be determined based on the vector of variables. In an embodiment, each variable of the vector may be assigned a weight. The score of the vector may be determined based on a weighted value of each variable (e.g., the product of the value of each variable times its respective weight). In a further embodiment, the score may be an average of weighted values of the variables of the vector. In yet a further embodiment, S245 includes sending the determined score to the decision engine.

At S250, the determined vector is sent to the decision engine. In an embodiment, the determined vector is sent in real-time. In another embodiment, a first portion of the vector may be sent in real-time and a second portion may be sent at a later time.

It should be noted that the example variables described herein are not limiting, and that other variables may be utilized. Additional variables such as, but not limited to, date of birth, education, geographical location, social relationships, type of mobile device, affiliations with financial institutions (e.g., possession of a bank account or trading account), indications of travel, and the like may be equally utilized without departing from the scope of the disclosure. It should be further noted that variables utilized by decision engines for determining other types of decisions or recommendations may also be utilized.

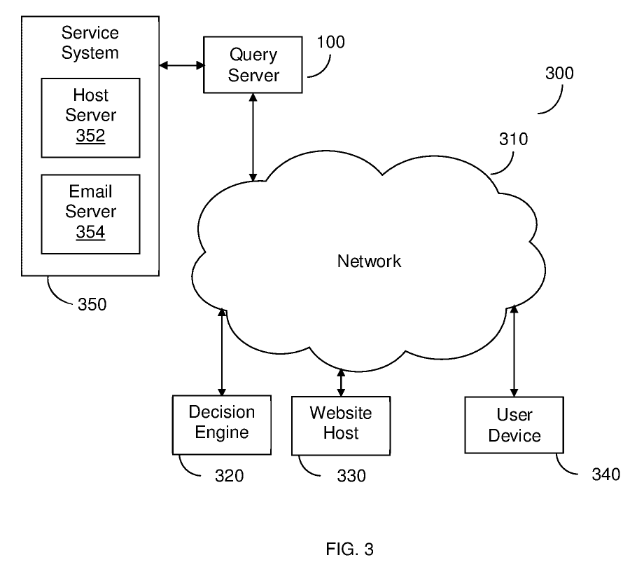

FIG. 3 is an example network diagram 300 illustrating deployment of the query server 100 utilized to describe the various disclosed embodiments. In the example network diagram 300, a network 310 is communicatively connected to the query server 100, a decision engine 320, a website host 330, and a user device 340. The network 310 may be, but is not limited to, a wireless, a cellular or wired network, a local area network (LAN), a wide area network (WAN), a metro area network (MAN), the Internet, the worldwide web (WWW), similar networks, and any combination thereof.

In some embodiments, the network 310 may be further communicatively connected to a service system 350 of a service such as, e.g., an electronic mail service. The service system 350 may include, but is not limited to, a host server 352 and an email server 354. The host server 352 may provide authentication tokens utilized for authenticating access to data of the email server 354 as described further herein above with respect to FIG. 2. It should be noted that the host server 352 and the email server 354 are shown in FIG. 3 as components of a single system merely for simplicity purposes and without limitation on the disclosed embodiments.

A user of the user device 340 may request a service provided by a website hosted via the website host 330. The website host 330 may be a server hosting one or more websites which may require decisions (e.g., a website of a loan company). To determine whether the website should provide the service to the user device 340, a query is sent to the decision engine 320. The decision engine 320 is configured to receive a vector of variables determined based on queries from the query server 100 to the service system 350 as described further herein above with respect to FIG. 2. The decision engine 320 is further configured to determine, based on the vector of variables, a decision regarding whether to provide the service to the user device 340. Based on the determined decision, the website hosted via the website host 330 may, e.g., grant or deny the user's request for the service.

As a non-limiting example, a user of the user device 340 may request approval for a loan to purchase a car on a car dealership website hosted by the website host 330. The website host 330 sends a query to the decision engine 320. The decision engine 320 receives, from the query server 100, a vector of variables including a first set of identity variables, a second set of credit variables, and a third group of affordability variables determined based on information contained in emails of an electronic mail account of the user hosted by the email server 354. Based on the identity, credit, and affordability variables, the decision engine 320 determines that the loan should be approved and sends the decision to the website host 330. The website grants the user's request for a loan.

It should be understood that the embodiments disclosed herein are not limited to the specific architecture illustrated in FIG. 3, and other architectures may be equally used without departing from the scope of the disclosed embodiments. Specifically, the query server 100 may reside in a cloud computing platform, a datacenter, and the like. Moreover, in an embodiment, there may be a plurality of query servers operating as described hereinabove and configured to either have one as a standby, to share the load between them, or to split the functions between them.

Additionally, in some embodiments, the decision engine 320 may be integrated in the host server 330. Further, the embodiments discussed with respect to FIG. 3 are described as interacting with only one user device 340 merely for simplicity purposes and without limitations on the disclosure. Requests from additional user devices 340 may be processed without departing from the scope of the disclosed embodiments.

It should be noted that the embodiments described herein are discussed with respect to providing data from electronic mail accounts merely for simplicity purposes and without limitations on the disclosure. Data from other message services such as, but not limited to, social media messaging, instant messaging, and the like, may be equally utilized without departing from the scope of the disclosure. Further, in some embodiments, data may be provided from a plurality of sources. For example, the host server 330 may host a social media service. The social media service includes login information of a user account such as login information of an email user account (e.g. username and password). The social media account may also include data such as messages between one or more user accounts, associated user accounts, personal information, and the like.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing data to decision engines, comprising:
providing an alternate login frame to a user device accessing a website;
receiving, from a host server, an authentication token for accessing data stored in an electronic mail server, when login credentials are successfully provided via the alternate login frame;
sending the received authentication token to the electronic mail server;
upon being granted access to at least a portion of the data stored in the electronic mail server, determining, based on the at least a portion of the data, a vector of variables, the vector including at least one set of variables; and
sending, to a decision engine in real-time, the determined vector.

2. The method of claim 1, wherein the determined vector includes a first set of identity variables, a second set of credit variables, and a third set of affordability variables.

3. The method of claim 1, further comprising:
determining whether a user of the user device is associated with an account of a supported service, wherein the alternate login frame is provided to the user device when it is determined that the user of the user device is associated with an account of a supported service.

4. The method of claim 1, wherein determining the vector of variables further comprises:
querying, for each set of variables, the electronic mail server, wherein the vector is determined based on the results of the query.

5. The method of claim 4, wherein determining the vector of variables further comprises:
obtaining, for each of at least one variable of the vector, a first value;
querying, for each of the at least one variable of the vector, the electronic mail server for a second value; and
determining at least one match between the at least one first value and the at least one second value, wherein the vector includes the determined at least one match.

6. The method of claim 4, wherein each determined match is within a range of values.

7. The method of claim 1, further comprising:
assigning a weight to at least two variables of the vector; and
determining, for each of the at least two variables of the vector, a score based on a value of the variable and the assigned weight of the variable.

8. The method of claim 1, further comprising:
receiving, from the host server, the login credentials.

9. The method of claim 1, wherein determining the vector of variables further comprises:
identifying, based on the at least a portion of the data, a job title; and
querying, based on the identified job title, a database of job titles and associated incomes; and
determining, based on the query to the database of job titles and associated incomes, an income value, wherein the vector includes the determined income value.

10. A non-transitory computer readable medium having stored thereon instructions for causing one or more processing units to execute a method, the method comprising:
providing an alternate login frame to a user device accessing a website;
receiving, from a host server, an authentication token for accessing data stored in an electronic mail server, when login credentials are successfully provided via the alternate login frame;
sending the received authentication token to the electronic mail server;
upon being granted access to at least a portion of the data stored in the electronic mail server, determining, based on the at least a portion of the data, a vector of variables, the vector including at least one set of variables; and
sending, to a decision engine in real-time, the determined vector.

11. A system for providing data to decision engines, comprising:
a processing circuitry; and
a memory, the memory containing instructions that, when executed by the processing circuitry, configure the system to:
provide an alternate login frame to a user device accessing a website;
receive, from a host server, an authentication token for accessing data stored in an electronic mail server, when login credentials are successfully provided via the alternate login frame;
send the received authentication token to the electronic mail server;
upon being granted access to at least a portion of the data stored in the electronic mail server, determine, based on the at least a portion of the data, a vector of variables, the vector including at least one set of variables; and
send, to a decision engine in real-time, the determined vector.

12. The system of claim 11, wherein the determined vector includes a first set of identity variables, a second set of credit variables, and a third set of affordability variables.

13. The system of claim 1, wherein the system is further configured to:
determine whether a user of the user device is associated with an account of a supported service, wherein the alternate login frame is provided to the user device when it is determined that the user of the user device is associated with an account of a supported service.

14. The system of claim 11, wherein the system is further configured to:
query, for each set of variables, the electronic mail server, wherein the vector is determined based on the results of the query.

15. The system of claim 14, wherein the system is further configured to:
obtain, for each of at least one variable of the vector, a first value;
query, for each of the at least one variable of the vector, the electronic mail server for a second value; and
determine at least one match between the at least one first value and the at least one second value, wherein the vector includes the determined at least one match.

16. The system of claim 14, wherein each determined match is within a range of values.

17. The system of claim 11, wherein the system is further configured to:
assign a weight to at least two variables of the vector; and
determine, for each of the at least two variables of the vector, a score based on a value of the variable and the assigned weight of the variable.

18. The system of claim 11, wherein the system is further configured to:
receive, from the host server, the login credentials.

19. The system of claim 11, wherein the system is further configured to:
identify, based on the at least a portion of the data, a job title; and
query, based on the identified job title, a database of job titles and associated incomes; and
determine, based on the query to the database of job titles and associated incomes, an income value, wherein the vector includes the determined income value.
